(19) United States
(12) Patent Application Publication
(10) Pub. No.: US 2014/0089169 A1
(43) Pub. Date: Mar. 27, 2014

(54) System and Method of Processing Payment Transactions via Mobile Devices

(71) Applicants: Shashi Kapur, Fort Lauderdale, FL (US); Ralph A. Bianco, Lagrangeville, NY (US)

(72) Inventors: Shashi Kapur, Fort Lauderdale, FL (US); Ralph A. Bianco, Lagrangeville, NY (US)

(21) Appl. No.: 13/624,279

(22) Filed: Sep. 21, 2012

(51) Int. Cl. G06Q 20/32

(52) U.S. Cl. 705/39

(57) ABSTRACT

A system and method for processing payment transactions via mobile devices are provided. An adaptive payment server is configured to accept requests from a mobile device to process different types of payment transactions via various types of payment devices (for example, credit cards, debit cards, EBT cards, or other payment cards). Credit card transactions, debit card transactions, EBT cash benefits transactions, and/or EBT food stamps transactions may be processed based on identification information retrieved from a corresponding payment device via the mobile device.

### CROSS-REFERENCE TO RELATED APPLICATIONS

This application is related to U.S. patent application Ser. No. ______ entitled “System and Method of Processing PIN-Based Payment Transactions via Mobile Devices,” concurrently filed herewith. The entirety of the aforementioned application is herein incorporated by reference.

### FIELD OF THE INVENTION

The invention relates to processing payment transactions. In particular, the invention relates to processing payment transactions via various types of payment devices using a mobile device.

### BACKGROUND OF THE INVENTION

Mobile payment systems increasingly are being used to process payment transactions. The payment transactions can be used to transfer funds from one account to another account for payment of goods/services or processing other fund transfer requests. A mobile device may receive information associated with various payment devices (for example, credit cards, debit cards, EBT (electronic benefit transfer) cards, and/or other payment devices. What is needed is a system that is capable of accepting requests from mobile devices to process different types of payment transactions via various types of payment devices.

### SUMMARY OF THE INVENTION

Various systems, computer program products, and methods for processing payment transactions via mobile devices are provided. According to various implementations of the invention, a method of processing a payment transaction via a mobile device may include receiving, from a mobile device, a request to process a credit card transaction via a credit card, the request comprising first identification information retrieved from the credit card via the mobile device. In some implementations of the invention, the method may include receiving, from the mobile device, a request to process a debit card transaction via a debit card, the request comprising second identification information retrieved from the debit card via the mobile device. In some implementations of the invention, the method may include processing the credit card transaction based on the first identification information. In some implementations of the invention, the method may include processing the debit card transaction based on the second identification information.

### BRIEF DESCRIPTION OF THE DRAWINGS

FIG. 1 is a block diagram illustrating an example of a system for processing payment transactions according to various implementations of the invention.

FIG. 2 illustrates an exemplary screenshot depicting an interface associated with a mobile device, according to various aspects of the invention.

FIG. 3 is a flow diagram illustrating an example of a process of processing a payment transaction at an adaptive payment server, according to various implementations of the invention.

### DETAILED DESCRIPTION

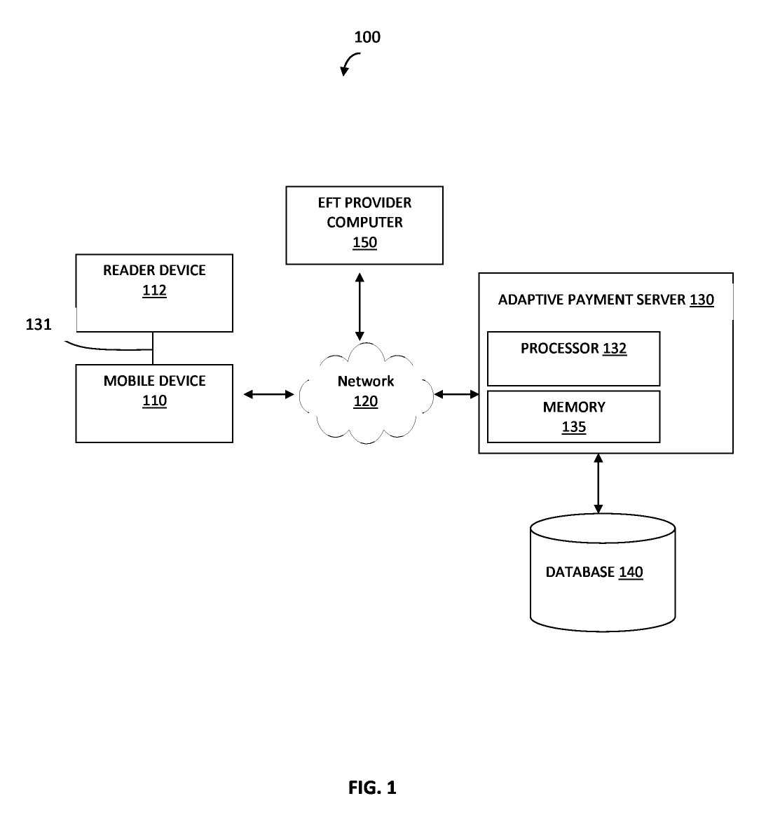

According to various implementations of the invention, various systems and methods may facilitate payment transactions via mobile devices. FIG. 1 is a block diagram illustrating a system 100 for processing payment transactions via mobile devices, according to various implementations of the invention. According to various implementations of the invention, system 100 may be used to process different types of payment transactions via various types of payment devices. In some implementations, a payment transaction may include, for instance, an online purchase, a funds transfer (for example, Electronic Funds Transfer (“EFT), which involves electronically transferring funds or money from one account to another), and/or other transaction that transfers money to/from a financial account. A payment device may include a credit card, a debit card, an EBT (electronic benefit transfer) card, and/or other payment device that may be read via a reader device coupled to a mobile device for the purposes of processing a payment transaction. In some implementations of the invention, the reader is removably coupled to the mobile device. In some implementations of the invention, the reader is embedded in the mobile device. In various implementations of the invention, the reader may read a magnetic strip of the payment device, interrogate/read an RFID chip of the payment device, or otherwise read information, electrically, magnetically, or optically, from the payment device as would be appreciated.

When a credit card is used to process the payment transaction, the transaction may be referred to as a “credit card transaction.” When a debit card is used to process the payment transaction, the transaction may be referred to as a “debit card transaction.” When an EBT card is used to process the payment transaction, the transaction may be referred to as an “EBT transaction” and may include an EBT cash benefits transaction, an EBT food stamps transaction, and/or other EBT transaction.

According to various implementations of the invention, system 100 may include, but is not limited to, a mobile device 110, a reader device 112 (also referred to as a “reader”), a network 120, an adaptive payment server 130, a database 140, and an EFT provider computer 150. In some implementations of the invention, adaptive payment server 130, mobile device 110, EFT provider computer 150, and database 140 may be communicably coupled to one another via a network 120. Network 120 may include a Local Area Network, a Wide Area Network, a cellular communications network, a Public Switched Telephone Network, and/or other network or combination of networks.

According to various implementations of the invention, mobile device 110 may include a mobile computing/processing device such as a wireless phone, a personal digital assistant, a smart phone, a tablet computing device, and/or other portable computing device that may be utilized to communicate information with adaptive payment server 130 over network 120. In some implementations, mobile device 110 may be used to perform secure payment transactions.

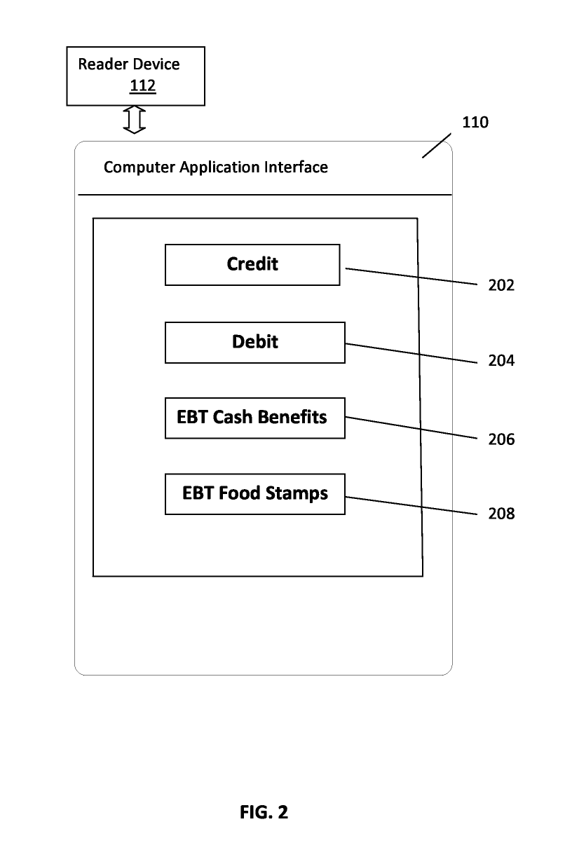

In some implementations, mobile device 110 may include a processor (not otherwise illustrated in FIG. 1), circuitry, and/or other hardware operable to execute computer-readable instructions and/or mobile applications. In some implementations, mobile device 110 may execute a mobile application (not otherwise illustrated in FIG. 1) that may configure mobile device 110 to generate and display a user interface that prompts for and receives a selection for a type of payment transaction to be processed via soft and/or hard keys of the mobile device 110. For example, the mobile application may configure mobile device 110 to generate and display a user interface depicted in FIG. 2. A user may be prompted to select whether a credit card transaction, a debit card transaction, an EBT cash benefits transaction, or an EBT food stamps transaction is to be processed. For example, a user may select option 202 when a credit card transaction is to be processed via a credit card. A user may select option 204 when a debit card transaction is to be processed via a debit card. A user may select option 206 when an EBT cash benefits transaction is to be processed via an EBT card. A user may select option 208 when an EBT food stamps transaction is to be processed via an EBT card. In some implementations, options 202, 204, 206, 208 may include buttons that may selected by the user, as depicted in FIG. 2. Other forms of interface elements may be used to indicate a selection of option 202, 204, 206, or 208 without departing from the scope of the invention. In some implementations, the type of transaction may be automatically determined based on information read by the reader from the payment device.

Referring back to FIG. 1, reader device 112 and mobile device 110 may be communicably coupled to one another via a bi-directional link 131, which can include a wired (such as via Universal Serial Bus, headphone/multi-function jack, or other wired link) or wireless link (such as BLUETOOTH or other wireless link). In some implementations, reader device 112 may be connected to or plugged in the mobile device 110, wherein the reader device 112 may be configured to accept/read a payment device (for example, a credit card, debit card, EBT card, and/or other payment device/card) associated with a user (account holder) performing a payment transaction. In some implementations, the reader device 112 may be plugged into a headphone/audio jack of the mobile device 110. In some implementations, reader device 112 may be embedded in the mobile device 110, as hardware and/or software configured to interrogate/read the payment device associated with the user performing a payment transaction.

In some implementations, the account holder is a person/user or other entity that is a payment cardholder, a user using the system to make a payment, a user using the system to transfer funds, and/or other person or entity using the system to process a payment transaction. Those having skill in the art will appreciate that the invention described herein may work with various system configurations.

In some implementations, the mobile application executed by mobile device 110 may be configured to receive identification information associated with the user when a payment device (for example, credit card, debit card, EBT card, or other card) is swiped using the reader device 112. In other words, the reader device 112 may read the identification information associated with the payment device, encrypt the identification information, and provide the encrypted identification information to the mobile application. In some implementations, the mobile application may cause the communication of the encrypted identification information to adaptive payment server 130 for processing of a payment transaction. In some implementations, mobile device 110 may include a memory (not otherwise illustrated in FIG. 1) that includes one or more tangible (i.e., non-transitory) computer readable media. The memory may include one or more instructions that when executed by the processor configures the processor to perform functions of mobile device 110/mobile application.

For ease of description, the following implementations are described in reference to the user selecting the type of payment via the mobile device and “swiping” the payment device. Other implementations, such as those determining the type of payment based on the information read from the payment device or those interrogating/reading the payment device using mechanisms other than magnetic card swipes, would be readily appreciated by those having ordinary skill in the art.

In some implementations, when option 202 is selected, mobile application may prompt the user to swipe a credit card for a credit card transaction. When the credit card is swiped using the reader device 112, the reader device 112 may read first identification information associated with the credit card, encrypt the first identification information, and provide the encrypted first identification information to the mobile application. In some implementations, the mobile application may prompt for and receive a signature for the user used to authenticate/process the credit card transaction. In some implementations, the mobile application may cause the communication of a request to process the credit card transaction via the credit card to adaptive payment server 130. In some implementations, the request may include the encrypted first identification information retrieved from the credit card via the mobile device for processing of the credit transaction.

According to various implementations of the invention, the first identification information may include, among other things, a credit card number, a bank account number, or other identifier that identifies a financial account/payment account used for the credit card transaction. The payment account may be associated with the payment device (i.e., credit card). In some implementations, the first identification information may further include a name of the cardholder/account holder (such as a name of the user), a telephone number of the cardholder, a mailing address of the cardholder, and/or other information related to the credit card transaction.

In some implementations, when option 204 is selected, mobile application may prompt the user to swipe a debit card for a debit card transaction. When the debit card is swiped using the reader device 112, the reader device 112 may read second identification information associated with the debit card, encrypt the second identification information, and provide the encrypted second identification information to the mobile application. In some implementations, in response to receipt of the encrypted second identification information from reader device 112, mobile application may configure mobile device 110 to generate and display a user interface that prompts for and receives a PIN (referred to hereinafter as “debit card PIN”) via soft and/or hard keys of the mobile device 110. Mobile device 110 may communicate the debit card PIN to reader device 112. Reader device 112 may encrypt the debit card PIN and provide the encrypted debit card PIN to the mobile application. The debit card PIN may include a conventional four-digit predefined secret associated with the financial account or other secret information used to authenticate the debit card transaction.

According to various implementations of the invention, the second identification information may include, among other things, a debit card number, a bank account number, or other identifier that identifies a financial account/payment account used for the debit card transaction. The payment account may be associated with the payment device (i.e., debit card). In some implementations, the second identification information may further include a name of the cardholder/account holder (such as a name of the user), a telephone number of the cardholder, a mailing address of the cardholder, and/or other information related to the debit card transaction.

In some implementations, the mobile application may cause the communication of a request to process the debit card transaction via the debit card to adaptive payment server 130. In some implementations, the request may include the encrypted second identification information retrieved from the debit card via the mobile device for processing of the debit transaction. In some implementations, the request may include the encrypted debit card PIN.

In some implementations, when option 206 is selected, mobile application may prompt the user to swipe an EBT card for an EBT cash benefits transaction. In some implementations, the EBT card may include an EBT debit card issued to the user. When the EBT debit card is swiped using the reader device 112, the reader device 112 may read third identification information associated with the EBT debit card, encrypt the third identification information, and provide the encrypted third identification information to the mobile application. In some implementations, in response to receipt of the encrypted third identification information from reader device 112, mobile application may configure mobile device 110 to generate and display a user interface that prompts for and receives a PIN (referred to hereinafter as “first EBT PIN”) via soft and/or hard keys of the mobile device 110. Mobile device 110 may communicate the first EBT PIN to reader device 112. Reader device 112 may encrypt the first EBT PIN and provide the encrypted first EBT PIN to the mobile application. The first EBT PIN may include a conventional four-digit predefined secret associated with the financial account or other secret information used to authenticate the EBT cash benefits transaction.

According to various implementations of the invention, the third identification information may include, among other things, an EBT debit card number, a bank account number, or other identifier that identifies a financial account/payment account used for the EBT cash benefits transaction. The payment account may be associated with the payment device (i.e., EBT debit card). In some implementations, the third identification information may further include a name of the cardholder/account holder (such as a name of the user), a telephone number of the cardholder, a mailing address of the cardholder, and/or other information related to the EBT cash benefits transaction.

In some implementations, the mobile application may cause the communication of a request to process the EBT cash benefits transaction via the EBT debit card to adaptive payment server 130. In some implementations, the request may include the encrypted third identification information retrieved from the EBT debit card via the mobile device for processing of the EBT cash benefits transaction. In some implementations, the request may include the encrypted first EBT PIN.

In some implementations, when option 208 is selected, mobile application may prompt the user to swipe an EBT card for an EBT food stamps transaction. In some implementations, the EBT card may include an EBT debit card issued to the user. When the EBT debit card is swiped using the reader device 112, the reader device 112 may read fourth identification information associated with the EBT debit card, encrypt the fourth identification information, and provide the encrypted fourth identification information to the mobile application. In some implementations, in response to receipt of the encrypted fourth identification information from reader device 112, mobile application may configure mobile device 110 to generate and display a user interface that prompts for and receives a PIN (referred to hereinafter as “second EBT PIN”) via soft and/or hard keys of the mobile device 110. Mobile device 110 may communicate the second EBT PIN to reader device 112. Reader device 112 may encrypt the second EBT PIN and provide the encrypted second EBT PIN to the mobile application. The second EBT PIN may include a conventional four-digit predefined secret associated with the financial account or other secret information used to authenticate the EBT food stamps transaction.

According to various implementations of the invention, the fourth identification information may include, among other things, an EBT debit card number, a bank account number, or other identifier that identifies a financial account/payment account used for the EBT food stamps transaction. The payment account may be associated with the payment device (i.e., EBT debit card). In some implementations, the fourth identification information may further include a name of the cardholder/account holder (such as a name of the user), a telephone number of the cardholder, a mailing address of the cardholder, and/or other information related to the EBT food stamps transaction.

In some implementations, the mobile application may cause the communication of a request to process the EBT food stamps transaction via the EBT debit card to adaptive payment server 130. In some implementations, the request may include the encrypted fourth identification information retrieved from the EBT debit card via the mobile device for processing of the EBT food stamps transaction. In some implementations, the request may include the encrypted second EBT PIN.

In some implementations, the first identification information, the second identification information, the third identification information, and the fourth identification can be stored using various tangible media such as, for example, a magnetic strip, a smart chip, a Radio Frequency Identification (“RFID”) tag, other Near Field Communication (“NFC”) tag, and/or other tangible medium that can be used to store and retrieve the identification information. In some implementations, the medium may be coupled to various payment devices, which can include, for example, a payment card (such as, a credit card, a debit card, an EBT card, etc.), a key fob, a mobile device (such as a mobile device having an NFC tag), or other devices that can house or otherwise be used to carry the medium.

While system 100 is described as being used to process credit card transactions via credit cards, debit card transactions via debit cards, EBT cash benefits and EBT food stamps transactions via EBT cards, system 100 may be used to process other types of payment transactions (for example, signature debit transactions or other transactions) via various other types of payment devices without departing from the scope of the invention.

As such, the foregoing are non-limiting examples associated with various implementations of the invention. Other uses and implementations of system 100 with respect to various system components will be apparent to those skilled in the art based on the description below.

In some implementations of the invention, system 100 may process different types of payment transactions by gathering encrypted first identification information, encrypted second identification information and associated encrypted debit card PIN, encrypted third identification information and associated encrypted first EBT PIN, or encrypted fourth identification information and associated encrypted second EBT PIN from mobile device 110. In some implementations, for example, reader device 112 may obtain first identification information, second identification information, third identification information, or fourth identification information from the corresponding payment device and encrypt the obtained information. In some implementations, reader device 112 may receive debit card PIN, first EBT PIN, and second EBT PIN from the mobile device and encrypt the PINs. In some implementations, reader device 112 may use Triple Data Encryption Algorithm (commonly known as “Triple DES”), Advanced Encryption Standard (“AES”), or other encryption techniques for encrypting the identification information and the PIN information. In some implementations, reader device 130 uses Derived Unique Key Per Transaction (“DUKPT”) key management to further enhance security.

In some implementations, mobile device 110 may receive the encrypted first identification information, encrypted second identification information and encrypted debit card PIN, third identification information and encrypted first EBT PIN, or fourth identification information and encrypted second EBT PIN from the reader device 112 via link 131 for processing an associated payment transaction. In some implementations, mobile device 110 communicates the encrypted first identification information, encrypted second identification information and encrypted debit card PIN, third identification information and encrypted first EBT PIN, or fourth identification information and encrypted second EBT PIN to adaptive payment server 130 for processing the associated payment transaction.

In some implementations of the invention, adaptive payment server 130 may receive the encrypted first identification information, encrypted second identification information and encrypted debit card PIN, third identification information and encrypted first EBT PIN, or fourth identification information and encrypted second EBT PIN from mobile device 110. In some implementations, adaptive payment server 130 may decrypt: the encrypted first identification information, the encrypted second identification information and the encrypted debit card PIN, the encrypted third identification information and the encrypted first EBT PIN or the encrypted fourth identification information and the encrypted second EBT PIN for processing the associated payment transaction. For example, adaptive payment server 130 may: decrypt the encrypted first identification information for processing the credit card transaction, decrypt the encrypted second identification information and encrypted debit card PIN for processing the debit card transaction, decrypt the encrypted third identification information and the encrypted first EBT PIN for processing the EBT cash benefits transaction, and decrypt the encrypted fourth identification information and the encrypted second EBT PIN for processing the EBT food stamps transaction.

In some implementations of the invention, each type of payment transaction may be processed via an EFT network. In these implementations, processing the payment transaction may include generating a funds transfer request to an EFT provider (via EFT provider computer 150) such as, without limitation, SHAZAM, NYCE, PULSE, STAR, INTERLINK, and/or other entity that provides EFTs. In these implementations, adaptive payment server 130 may communicate an EFT request associated with the financial account based on the identification information (for example, first, second, third, or fourth identification information) associated with the payment transaction (for example, credit card, debit card, EBT cash benefits, or EBT food stamps, respectively) being processed. In some implementations of the invention, the EFT request may include, without limitation, an ISO 8583 payment message supported by various EFT networks. As would be appreciated, each network may adapt the ISO 8583 standard for its own use with custom fields and custom usages. As would be further appreciated, the placement of fields in different versions (such as 1987, 1993 and 2003) of the standard varies. In some implementations, one EFT network may act as a gateway to other EFT networks to provide universal coverage.

In some implementations, adaptive payment server 130 may cause the amount of funds to be transferred based on the EFT request. In some implementations of the invention, the EFT is processed by or otherwise fulfilled by an EFT provider (such as via EFT provider computer 150).

In some implementations of the invention, adaptive payment server 130 may receive an indication of an amount of funds to be transferred in the request to process a particular type of payment transaction. In these implementations, adaptive payment server 130 may receive a target account identifier that indicates a target account to which the amount of funds should be transferred. In some implementations, adaptive payment server 130 may cause the amount of funds to be transferred from the financial account/payment account to the target account. Adaptive payment server 130 may do so by generating, for example, an EFT request that indicates the payment account, the target account, the PIN (in case of a debit card transaction or an EBT transaction), and amount of funds to be transferred.

In some implementations of the invention, upon completion of a payment transaction, a receipt may be communicated to the customer/account holder. In some implementations, the receipt may be communicated via SMS text or electronic mail. In some implementations, the receipt may include various transaction data such as, without limitation, a name of the retailer where the transaction was processed, a location/address of the retailer, an account identifier such as a card number, a terminal number where the transaction was processed, a date, a time, a sequence number or other transaction identifier, a type of transaction (such as “credit, debit, EBT or other”), a monetary amount of the transaction, a ledger balance associated with the account, and an available balance associated with the account.

In some implementations of the invention, mobile device 110 may store a history of transactions. The history may include, without limitation, a phone number, an account identifier such as a card number, a date, a time, a sequence number, a type of transaction (such as credit, debit, EBT, or other), a monetary amount of the transaction, and a response indicator (such as “text response”). In this manner, a merchant or other users/operators of these devices may have a log of transactions in the event that a particular transaction is questioned.

According to various implementations of the invention, adaptive payment server 130 may include a processor 132, a memory 135, and/or other components that facilitate the functions of adaptive payment server 130 described herein. In some implementations of the invention, processor 132 includes one or more processors configured to perform various functions of the adaptive payment server 130. In some implementations of the invention, memory 135 includes one or more tangible (i.e., non-transitory) computer readable media. Memory 135 may include one or more instructions that when executed configure processor 132 to perform the functions of adaptive payment server 130. In some implementations, memory 135 may include one or more instructions stored on tangible computer readable media that when executed at a remote device, such as reader device 112 or mobile device 110, cause the remote device to perform various functions of the remote device described herein and to facilitate interaction with adaptive payment server 130, as described herein. For example, memory 135 may include instructions (i.e., a mobile application) that may be downloaded by mobile device 110. The mobile application when executed may cause mobile device 110 to communicate with adaptive payment server 130 in order to perform various functions described herein. Similarly, instructions may be downloaded by reader device 112 in order to likewise configure reader device 112 to communicate with adaptive payment server 130.

In some implementations, database 140, which may include information related to a payment account, such as, for example, credit card numbers, debit card numbers, EBT card numbers, account holder contact information, account holder information, an identity of mobile device 110 used by the account holder (for example device identifier), and/or other information. In some implementations, database 140 may store the first identification information, the second identification information, the third identification information, and/or the fourth identification information along with the associated payment account information. In some implementations, database 140 may store the encrypted first identification information, second identification information, third identification information, and/or fourth identification information. In implementations, database 140 may store the debit card PIN, first EBT PIN, or second EBT PIN. In some implementations, database 140 may store encrypted debit card PIN, encrypted first EBT PIN, or encrypted second EBT PIN. In some implementations, the PIN information and/or the encrypted PIN information may be removed from database 140 when no longer needed in order to maintain security of the PIN information. According to various implementations of the invention, examples of database 140, include, for instance, a relational database, a filesystem, and/or other device or data representation configured for data storage.

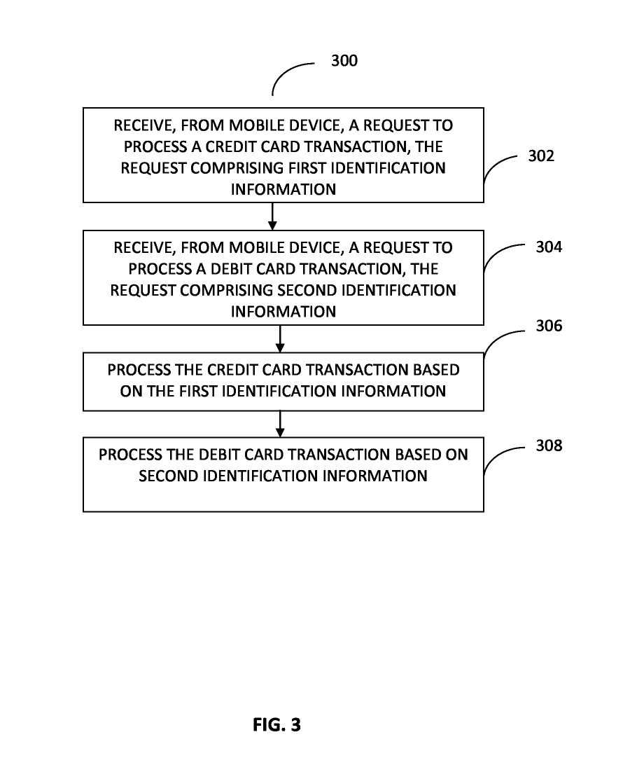

FIG. 3 is a flow diagram illustrating a process 300 for processing a payment transaction via a mobile device, according to various implementations of the invention. The various processing operations and/or data flows depicted in FIG. 3 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations of the invention, in an operation 302, process 300 may include receiving, from the mobile device, a request to process a credit card transaction. In some implementations, the request may include first identification information retrieved from the credit card via the mobile device. In some implementations, the request may also include an indication of an amount of funds to be transferred.

In some implementations, the first identification information may include a first identifier (for example, credit card number, bank account number, and/or other identifier) that identifies a payment account associated with the credit card. In some implementations, process 300 may receive encrypted first identification information from the mobile device, wherein the encrypted first identification information may include the encrypted first identifier.

In some implementations of the invention, in an operation 304, process 300 may include receiving, from the mobile device, a request to process a debit card transaction. In some implementations, the request may include second identification information retrieved from the debit card via the mobile device. In some implementations, the request may also include an indication of an amount of funds to be transferred.

In some implementations, the second identification information may include a second identifier (for example, debit card number, bank account number, and/or other identifier) that identifies a payment account associated with the debit card. In some implementations, the second identifier is retrieved from the debit card via the mobile device.

In some implementations, the request may further include a debit card PIN obtained from the user via the mobile device. In some implementations, process 300 may receive encrypted second identification information from the mobile device, wherein the encrypted second identification information may include the encrypted second identifier. In some implementations, process 300 may receive the encrypted debit card PIN. In some implementations, process 300 may receive a request to process a debit card transaction, wherein the request comprises encrypted second identification information, encrypted debit card PIN, and an amount of funds to be transferred.

In some implementations, in an operation 306, process 300 may process the credit card transaction based on the first identification information. In some implementations, process 300 may decrypt the encrypted first identification information and process the credit card transaction based on the decrypted first identification information. In some implementations, process 300 may process the credit card transaction based on the first identification information/decrypted first identification information, and the amount of funds to transfer included in the request to process the credit card transaction.

In some implementations, in an operation 308, process 300 may process the debit card transaction based on the second identification information. In some implementations, process 300 may decrypt the encrypted second identification information and/or decrypt the encrypted debit card PIN. In some implementations, process 300 may process the debit card transaction based on the decrypted second identification information and/or the decrypted debit card PIN. In some implementations, process 300 may process the debit card transaction based on the decrypted second identification information, the decrypted debit card PIN, and the amount of funds to transfer included in the request to process the debit card transaction.

In some implementations, process 300 may similarly process EBT cash benefits transaction and EBT food stamps transaction based on the third identification information/first EBT PIN and fourth identification information/second EBT PIN, respectively.

Implementations of the invention may be made in hardware, firmware, software, or any suitable combination thereof. Implementations of the invention may also be implemented as instructions stored on a machine-readable medium, which may be read and executed by one or more processors. A tangible machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. An adaptive payment server for processing payment transactions, comprising:
a processor configured to:
receive, from a mobile device, a request to process a credit card transaction via a credit card, the request comprising first identification information retrieved from the credit card via the mobile device;
receive, from the mobile device, a request to process a debit card transaction via a debit card, the request comprising second identification information retrieved from the debit card via the mobile device;
process the credit card transaction based on the first identification information; and
process the debit card transaction based on the second identification information.

2. The server of claim 1, wherein the first identification information comprises a first identifier that identifies a payment account associated with the credit card and the second identification information comprises a second identifier that identifies a payment account associated with the debit card.

3. The server of claim 2, wherein the first identifier is encrypted, and wherein the request to process the credit card transaction comprises the encrypted first identifier.

4. The server of claim 2, wherein the second identifier is encrypted, and wherein the request to process the debit card transaction comprises the encrypted second identifier and an encrypted debit card PIN.

5. The server of claim 2, wherein the first identifier and the second identifier are encrypted, wherein the request to process the credit card transaction comprises the encrypted first identifier, the request to process the debit card transaction comprises the encrypted second identifier and an encrypted debit card PIN, and wherein the processor is further configured to:
decrypt the encrypted first identifier;
decrypt the encrypted second identifier and the encrypted debit card PIN;
process the credit card transaction based on the decrypted first identifier; and
process the debit card transaction based on the decrypted second identifier and the decrypted debit card PIN.

6. The server of claim 1, wherein the processor is further configured to:
receive, from the mobile device, a request to process an EBT cash benefits transaction via an EBT card, the request comprising third identification information retrieved from the EBT card via the mobile device; and
process the EBT cash benefits transaction based on the third identification information.

7. The server of claim 1, wherein the processor is further configured to:
receive, from the mobile device, a request to process an EBT food stamps transaction via an EBT card, the request comprising fourth identification information retrieved from the EBT card via the mobile device; and
process the EBT food stamps transaction based on the fourth identification information.

8. A method for processing payment transactions, comprising:
receiving, from a mobile device, a request to process a credit card transaction via a credit card, the request comprising first identification information retrieved from the credit card via the mobile device;
receiving, from the mobile device, a request to process a debit card transaction via a debit card, the request comprising second identification information retrieved from the debit card via the mobile device;
processing the credit card transaction based on the first identification information; and
processing the debit card transaction based on the second identification information.

9. The method of claim 8, wherein the first identification information comprises a first identifier that identifies a payment account associated with the credit card and the second identification information comprises a second identifier that identifies a payment account associated with the debit card.

10. The method of claim 9, wherein the first identifier is encrypted, and wherein the request to process the credit card transaction comprises the encrypted first identifier.

11. The method of claim 9, wherein the second identifier is encrypted, and wherein the request to process the debit card transaction comprises the encrypted second identifier and an encrypted debit card PIN.

12. The method of claim 9, wherein the first identifier and the second identifier are encrypted, wherein the request to process the credit card transaction comprises the encrypted first identifier, the request to process the debit card transaction comprises the encrypted second identifier and an encrypted debit card PIN, and wherein the method further comprising:
decrypting the encrypted first identifier;
decrypting the encrypted second identifier and the encrypted debit card PIN;
processing the credit card transaction based on the decrypted first identifier; and
processing the debit card transaction based on the decrypted second identifier and the decrypted debit card PIN.

13. The method of claim 8, wherein the method further comprising:
receiving, from the mobile device, a request to process an EBT cash benefits transaction via an EBT card, the request comprising third identification information retrieved from the EBT card via the mobile device; and
processing the EBT cash benefits transaction based on the third identification information.

14. The method of claim 8, wherein the method further comprising:
receiving, from the mobile device, a request to process an EBT food stamps transaction via an EBT card, the request comprising fourth identification information retrieved from the EBT card via the mobile device; and
processing the EBT food stamps transaction based on the fourth identification information.
